(19) United States
(12) Patent Application Publication
(10) Pub. No.: US 2025/0091358 A1
(43) Pub. Date: Mar. 20, 2025

(54) POSITIVE PRESSURE ADJUSTMENT MECHANISM AND LIQUID EJECTION DEVICE

(71) Applicant: SEIKO EPSON CORPORATION, Tokyo (JP)

(72) Inventors: Masaru KOBASHI, MATSUMOTO-SHI (JP); Nanami HAGA, SHIOJIRI-SHI (JP); Yuki HIRABAYASHI, SHIOJIRI-SHI (JP); Tomohiro KAWASAKI, SHIOJIRI-SHI (JP)

(21) Appl. No.: 18/885,232

(22) Filed: Sep. 13, 2024

(30) Foreign Application Priority Data
Sep. 15, 2023 (JP) 2023-149861

(51) Int. Cl. B41J 2/175; B41J 2/18

(52) U.S. Cl. CPC B41J 2/17596; B41J 2/18; B41J 2202/12

(57) ABSTRACT

It includes a supply chamber; a pressure chamber that has a first flexible section; a first communication path and a second communication path, that bring the supply chamber and the pressure chamber into communication; an opening and closing section having a first shaft section and a first valve section configured to open and close the first communication path; a first seal section that forms a seal between an outer periphery of the first shaft section and an inner periphery of the second communication path; and a pressurizing section configured to pressurize the first flexible section, wherein the first seal section includes a first arm section and a second arm section, the first arm section is closer to an outer periphery of the first shaft section the further along the first arm section in the first direction D1, and the second arm section is closer to an inner periphery of the second communication path the further along the second arm section in the first direction D1.

The present application is based on, and claims priority from JP Application Serial Number 2023-149861, filed Sep. 15, 2023, the disclosure of which is hereby incorporated by reference herein in its entirety.

### BACKGROUND

### 1. Technical Field

The present disclosure relates to a positive pressure adjustment mechanism and a liquid ejection device.

### 2. Related Art

For example, as in JP-A-H10-149223, there is a pressure reducing valve that is an example of a positive pressure adjustment mechanism. The pressure reducing valve includes a valve body, a valve element that is an example of an opening and closing section, and a sealing member that is an example of a first seal section. The valve body includes a primary pressure chamber as an example of a supply chamber, a secondary pressure chamber as an example of a pressure chamber, a first sliding hole as an example of a second communication path, and a valve hole as an example of a first communication path. The center axes of the first sliding hole and the valve hole coincide with each other. The valve element is inserted into the first sliding hole and the valve hole, and the valve element opens and closes the valve hole. The sealing member closes the gap between the first sliding hole and the valve element.

The sealing member in JP-A-H10-149223 is a so-called O-ring with a circular cross-section. The O-ring seals the gap between the first sliding hole and the valve element by being compressed and pressed. When the displacement amount of the O-ring is increased, the sealing degree is improved and the leakage is reduced. However, when the O-ring is crushed, the frictional resistance increases, so that it becomes difficult to move the valve element.

### SUMMARY

The positive pressure adjustment mechanism that solves the above problem includes:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section that forms a seal between an outer periphery of the shaft section and an inner periphery of the second communication path; and
a pressurizing section configured to pressurize the flexible section in a first direction which decreases volume of the pressure chamber, wherein
the first seal section includes a first arm section and a second arm section, the first arm section being closer to an outer periphery of the shaft section the further the first arm section is in first direction and the second arm section being closer to an inner periphery of the second communication path the further along the second arm section in the first direction.

The positive pressure adjustment mechanism that solves the above problem includes:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section provided at an outer periphery of the shaft section and configured to form a seal with an inner periphery of the second communication path, and
a pressurizing section configured to pressurize the flexible section in a first direction which decreases volume of the pressure chamber, wherein
the first seal section includes an arm section that is closer to an inner periphery of the second communication path the further along the arm section in the first direction.

A positive pressure adjustment mechanism that solves the above problem includes:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section arranged at an inner periphery of the second communication path and configured to form a seal with an outer periphery of the shaft section; and
a pressurizing section configured to pressurize the flexible section in a first direction which decreases volume of the pressure chamber, wherein
the first seal section has an arm section that is closer to an outer periphery of the shaft section the further along the arm section in the first direction.

The liquid ejection device that solves the above problem includes:
a liquid ejection head configured to eject liquid;
a positive pressure path configured to supply the liquid to the liquid ejection head;
a positive pressure adjustment mechanism having the above configuration provided at the positive pressure path.

A liquid ejection device that solves the above problem includes:
a liquid ejection head configured to eject liquid;
a positive pressure path configured to supply the liquid to the liquid ejection head;
a negative pressure path configured to collect the liquid from the liquid ejection head;
an positive pressure adjustment mechanism having the above configuration provided at the positive pressure path; and
a negative pressure adjustment mechanism arranged in the negative pressure path configured to adjust the negative pressure on the liquid ejection head side.

### BRIEF DESCRIPTION OF THE DRAWINGS

FIG. 1 is a schematic diagram of an embodiment of a liquid ejection device.

FIG. 2 is a schematic diagram of a positive pressure adjustment mechanism included in a liquid ejection device.

FIG. 3 is a cross-sectional view arrowed along line 3-3 in FIG. 2.

FIG. 4 is a schematic diagram of a negative pressure adjustment mechanism included in the liquid ejection device.

FIG. 5 is a schematic diagram of a first modified example of the positive pressure adjustment mechanism.

FIG. 6 is a schematic diagram of a second modified example of the positive pressure adjustment mechanism.

FIG. 7 is a schematic diagram of a fourth modified example of the positive pressure adjustment mechanism.

FIG. 8 is a schematic diagram of a fifth modified example of the liquid ejection device.

FIG. 9 is a schematic diagram of a sixth modified example of the liquid ejection device.

FIG. 10 is a schematic diagram of a seventh modified example of the liquid ejection device.

FIG. 11 is a schematic diagram of an eighth modified example of the liquid ejection device.

FIG. 12 is a schematic diagram of a ninth modified example of the liquid ejection device.

FIG. 13 is a schematic diagram of a tenth modified example of the liquid ejection device.

FIG. 14 is a schematic diagram of the eleventh modified example of the liquid ejection device.

FIG. 15 is a schematic diagram of a twelfth modified example of the liquid ejection device.

FIG. 16 is a schematic diagram of a thirteenth modified example of the liquid ejection device.

### DESCRIPTION OF EMBODIMENTS

Hereinafter, an embodiment of a positive pressure adjustment mechanism and a liquid ejection device will be described with reference to the drawings. The liquid ejection device is, for example, an inkjet type printer that ejects ink that is an example of a liquid, onto medium such as paper sheet, fabric, vinyl, plastic parts, metal parts, or the like to perform printing.

### Liquid Ejection Device

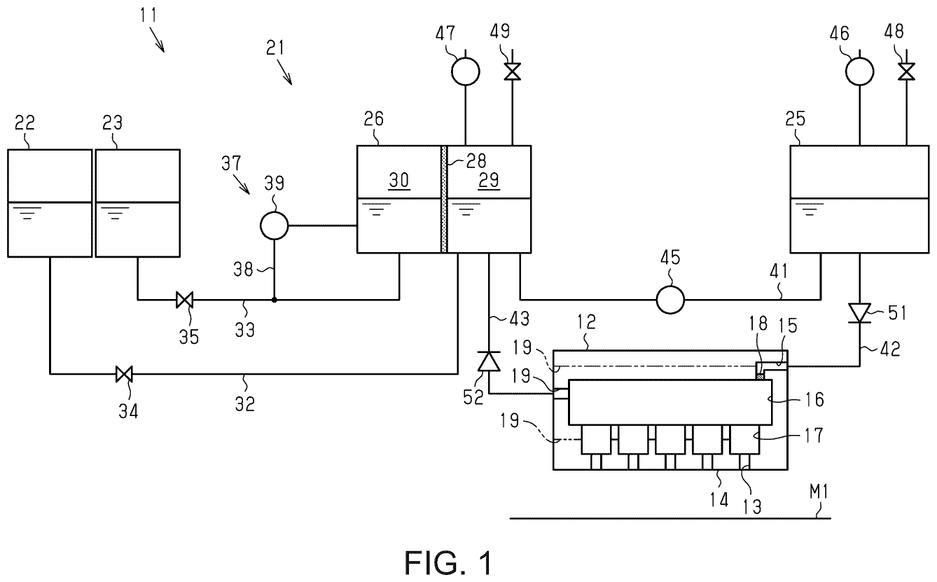

As shown in FIG. 1, a liquid ejection device 11 includes a liquid ejection head 12. The liquid ejection head 12 is configured to eject liquid. The liquid ejection head 12 is configured to eject liquid onto the medium M1. The liquid ejection head 12 has a nozzle face 14 through which one or more nozzles 13 open. The liquid ejection head 12 ejects liquid from the nozzle 13.

In the liquid ejection head 12, an introduction path 15, a common fluid chamber 16, and one or more individual fluid chambers 17 are formed. The introduction path 15, the common fluid chamber 16, and one or more individual fluid chambers 17 are spaces in the liquid ejection head 12. Liquid flows through the introduction path 15, the common fluid chamber 16, and one or more individual fluid chambers 17.

The introduction path 15 is a space for introducing liquid into the liquid ejection head 12. The common fluid chamber 16 communicates with the introduction path 15. The liquid is introduced into the common fluid chamber 16 through the introduction path 15. One or more individual fluid chambers 17 communicate with the common fluid chamber 16. The liquid is introduced into one or more individual fluid chambers 17 through the common fluid chamber 16. When a plurality of individual fluid chambers 17 are formed in the liquid ejection head 12, the plurality of individual fluid chambers 17 communicate with the common fluid chamber 16. One individual fluid chamber 17 communicates with one nozzle 13. Therefore, the same number of individual fluid chambers 17 as the nozzles 13 are formed in the liquid ejection head 12. The liquid ejection head 12 ejects liquid from the nozzle 13 by applying pressure to the liquid positioned in the individual fluid chamber 17.

The liquid ejection head 12 may include a filter 18. In one example, the filter 18 is positioned at the introduction path 15. Specifically, the filter 18 is positioned at an end section of the introduction path 15 that is coupled to the common fluid chamber 16. The filter 18 collects air bubbles, foreign matter, and the like contained in the liquid. By this, the liquid from which bubbles and foreign matter have been removed is introduced into the common fluid chamber 16 and the individual fluid chamber 17.

In the liquid ejection head 12, a lead-out path 19 may be formed. The lead-out path 19 is a space within the liquid ejection head 12 through which the liquid flows. The lead-out path 19 is a space for leading out the liquid from the liquid ejection head 12. Therefore, the liquid can flow in the liquid ejection head 12 from the introduction path 15 to the lead-out path 19. When the liquid stays for a long time, there is a risk that thickening or sedimentation occurs in the liquid. By the liquid flows in the liquid ejection head 12, the risk of thicken or settle of the liquid in the liquid ejection head 12 is reduced.

The lead-out path 19 extends from the introduction path 15, the common fluid chamber 16, or the individual fluid chamber 17. For example, the lead-out path 19 extends from the common fluid chamber 16. Therefore, the liquid passes through the liquid ejection head 12 by flowing through the introduction path 15, the common fluid chamber 16, and the lead-out path 19 in this order. The lead-out path 19 may extend from the introduction path 15 or may extend from the individual fluid chamber 17. The lead-out path 19 may extend from the introduction path 15 so that the liquid passes through the liquid ejection head 12 without passing through the filter 18.

The inside of the liquid ejection head 12 is usually maintained at a negative pressure. This is for forming a meniscus in the nozzle 13. By this, the liquid ejection head 12 can appropriately eject the liquid. Even when the liquid flows from the introduction path 15 to the lead-out path 19, the inside of the liquid ejection head 12 should be maintained at a negative pressure. When the negative pressure of the liquid ejection head 12 is eliminated, there is a risk that the meniscus may be broken. When the meniscus is broken, it is necessary to cause the nozzle 13 to re-form the meniscus.

The liquid ejection device 11 includes a liquid flow mechanism 21. The liquid flow mechanism 21 supplies the liquid to the liquid ejection head 12 by flowing the liquid. The liquid flow mechanism 21 may cause the moisturizing liquid to flow in addition to causing the liquid to flow. The moisturizing liquid is a liquid for moisturizing the liquid. The moisturizing liquid is, for example, an aqueous glycerin solution.

The liquid flow mechanism 21 may be coupled to a liquid source 22 and a moisture source 23. The liquid source 22 contains a liquid. The moisture source 23 contains moisture, that is, water. The liquid source 22 and the moisture source 23 may be a cartridge, a pack, or the like that may be detachable and attachable to the liquid ejection device 11, or may be a tank that can be refilled with liquid.

The liquid flow mechanism 21 may have a first tank 25 and a second tank 26. The first tank 25 can contain liquid to be supplied to the liquid ejection head 12. The second tank 26 can contain the liquid collected from the liquid ejection head 12.

The second tank 26 may have a moisture-permeable film 28. The moisture-permeable film 28 divides the inside of the second tank 26 into a liquid chamber 29 and a moisturizing liquid chamber 30. The liquid chamber 29 can contain liquid. The liquid chamber 29 is supplied with a liquid from the liquid source 22. The moisturizing liquid chamber 30 can contain a moisturizing liquid. Moisture is supplied to the moisturizing liquid chamber 30 from moisture source 23.

The moisture-permeable film 28 is a membrane that allows gas to permeate but does not allow liquid to permeate. Therefore, the moisture-permeable film 28 separates the liquid and the moisturizing liquid so that the liquid stored in the liquid chamber 29 and the moisturizing liquid stored in the moisturizing liquid chamber 30 are not mixed. The moisture-permeable film 28 is a porous membrane in which a plurality of pores are formed. In this pore, a meniscus is generated by the surface tension of the liquid. By this, the moisture-permeable film 28 allows gas to permeate through it, while preventing the permeation of liquids. The moisturizing liquid moisturizes the liquid by supplying moisture to the liquid through the moisture-permeable film 28.

The liquid flow mechanism 21 may include a liquid supply path 32 and a moisture supply path 33. The liquid supply path 32 is coupled to the liquid source 22 and the liquid chamber 29. The moisture supply path 33 is coupled to the moisture source 23 and the moisturizing liquid chamber 30.

The liquid flow mechanism 21 may have a liquid supply valve 34 and a moisture supply valve 35. The liquid supply valve 34 is positioned in the liquid supply path 32. When the liquid supply valve 34 opens, the liquid can be supplied from the liquid source 22 to the second tank 26. The moisture supply valve 35 is positioned in the moisture supply path 33. When the moisture supply valve 35 opens, moisture can be supplied from moisture source 23 to the second tank 26. Normally, the liquid supply valve 34 and the moisture supply valve 35 are closed. The liquid supply valve 34 opens when it is necessary to supply liquid to the second tank 26. The moisture supply valve 35 opens when it is necessary to supply moisture to the second tank 26.

The liquid flow mechanism 21 may include a stirring section 37. The stirring section 37 is attached to the second tank 26. The stirring section 37 stirs the moisturizing liquid stored in the moisturizing liquid chamber 30. By the stirring section 37 stirring the moisturizing liquid, the concentration of the moisturizing liquid is made uniform. By this, a risk that the concentration of the moisturizing liquid increases is reduced.

The stirring section 37 may have a stirring path 38 and a stirring pump 39. The stirring path 38 is coupled to the moisturizing liquid chamber 30 and the moisture supply path 33. The stirring pump 39 is positioned in the stirring path 38. The stirring pump 39 circulates the moisturizing liquid in the second tank 26 through the stirring path 38. By this, the moisturizing liquid is stirred.

The liquid flow mechanism 21 may have a coupling path 41, a positive pressure path 42, and a negative pressure path 43. The coupling path 41 couples the second tank 26 and the first tank 25. The positive pressure path 42 couples the first tank 25 and the liquid ejection head 12. That is, the first tank 25 is coupled to the positive pressure path 42. The negative pressure path 43 couples the liquid ejection head 12 and the second tank 26. That is, the second tank 26 is coupled to the negative pressure path 43. The coupling path 41, the positive pressure path 42, and the negative pressure path 43 circulate the liquid and supply the liquid to the liquid ejection head 12.

When the liquid circulates, it flows from the second tank 26 to the first tank 25 through the coupling path 41. When the liquid is circulated, it flows from the first tank 25 to the liquid ejection head 12 through the positive pressure path 42. When the liquid circulates, it flows from the liquid ejection head 12 to the second tank 26 through the negative pressure path 43. The positive pressure path 42 is a flow path for supplying liquid to the liquid ejection head 12. The negative pressure path 43 is a flow path for collecting liquid from the liquid ejection head 12.

The liquid flow mechanism 21 may include a liquid delivery section 45, a pressurizing pump 46, a vacuum pump 47, a first atmosphere air open valve 48, and a second atmosphere air open valve 49.

The liquid delivery section 45 is positioned in the coupling path 41. The liquid delivery section 45 sends the liquid from the second tank 26 to the first tank 25 through the coupling path 41.

The pressurizing pump 46 can pressurize the inside of the first tank 25. For example, the pressurizing pump 46 may pressurize the inside of the first tank 25 by feeding air into the first tank 25. When the pressurizing pump 46 pressurizes the inside of the first tank 25, the liquid in the first tank 25 flows out to the positive pressure path 42.

The vacuum pump 47 can depressurize the inside of the second tank 26. For example, the vacuum pump 47 may decompress the inside of the second tank 26 by sucking air from the inside of the second tank 26. The vacuum pump 47 normally depressurizes the inside of the second tank 26 so that the inside of the liquid ejection head 12 is maintained at a predetermined negative pressure.

When the vacuum pump 47 reduces the pressure in the second tank 26, the liquid flows into the second tank 26. For example, when the liquid supply valve 34 opens and the vacuum pump 47 is driven, the liquid flows from the liquid source 22 into the second tank 26 through the liquid supply path 32. When the vacuum pump 47 is driven with the moisture supply valve 35 open, the liquid flows from the moisture source 23 into the second tank 26 through the moisture supply path 33. When the vacuum pump 47 is driven in a state where the liquid supply valve 34 and the moisture supply valve 35 are closed, the liquid flows into the second tank 26 from the liquid ejection head 12 through the negative pressure path 43.

The first atmosphere air open valve 48 is coupled to the first tank 25. The first atmosphere air open valve 48 can open the inside of the first tank 25 to the atmosphere. The first atmosphere air open valve 48 can set the pressure applied to the liquid in the first tank 25 to atmospheric pressure.

The second atmosphere air open valve 49 is coupled to the second tank 26. The second atmosphere air open valve 49 can open the inside of the second tank 26 to the atmosphere. The second atmosphere air open valve 49 can set the pressure applied to the liquid in the second tank 26 to atmospheric pressure.

The liquid flow mechanism 21 may include a positive pressure adjustment mechanism 51 and a negative pressure adjustment mechanism 52. The positive pressure adjustment mechanism 51 is provided in the positive pressure path 42. The positive pressure adjustment mechanism 51 adjusts the positive pressure on the liquid ejection head 12 side. The negative pressure adjustment mechanism 52 is provided in the negative pressure path 43. The negative pressure adjustment mechanism 52 adjusts the negative pressure on the liquid ejection head 12 side.

### Positive Pressure Adjustment Mechanism

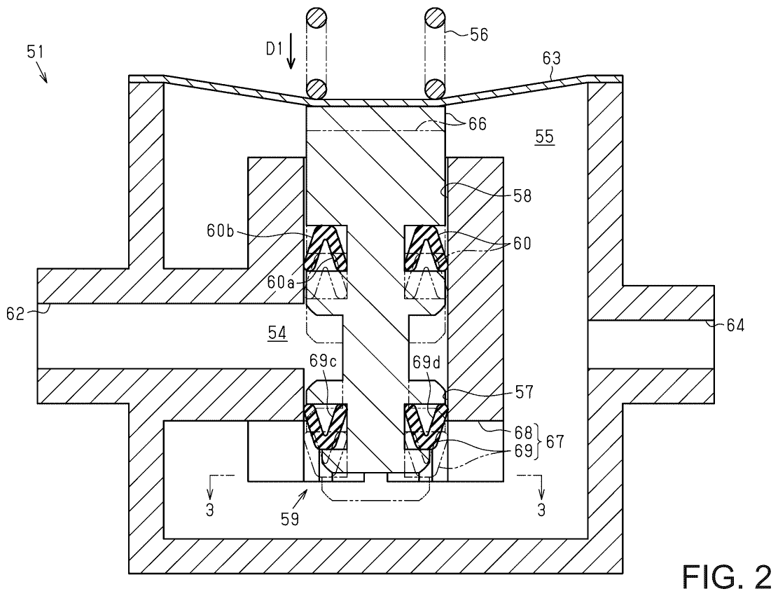

As shown in FIG. 2, the positive pressure adjustment mechanism 51 includes a supply chamber 54, a pressure chamber 55, a pressurizing section 56, a first communication path 57, a second communication path 58, an opening and closing section 59, and a first seal section 60.

The supply chamber 54 has a first inflow port 62 that is an example of an inflow port through which the liquid flows in.

The pressure chamber 55 is provided downstream of the supply chamber 54. The pressure chamber 55 includes a first flexible section 63 that is an example of a flexible section. The first flexible section 63 is formed of a flexible member having flexibility such as a diaphragm. The pressure chamber 55 has a first outflow port 64 that is an example of an outflow port through which the liquid flows out.

The pressurizing section 56 pressurizes the first flexible section 63 in the first direction D1 in which the volume of the pressure chamber 55 decreases. The pressurizing section 56 is provided outside the pressure chamber 55. The pressurizing section 56 presses the opening and closing section 59 via the first flexible section 63. The pressurizing section 56 is, for example, a spring.

The first communication path 57 communicates between the supply chamber 54 and the pressure chamber 55. The inner diameter of the first communication path 57 may be substantially the same as the inner diameter of the second communication path 58.

The second communication path 58 brings the supply chamber 54 and the pressure chamber 55 into communication. The second communication path 58 is provided coaxially with the first communication path 57. The first flexible section 63 and the pressurizing section 56 may be positioned on the shafts of the first communication path 57 and the second communication path 58. The second communication path 58 is positioned closer to the first flexible section 63 than the first communication path 57. The pressurizing section 56, the first flexible section 63, the second communication path 58, and the first communication path 57 may be arranged in this order in the first direction D1.

The opening and closing section 59 includes a first shaft section 66 as an example of the shaft section, and a first valve section 67 as an example of the valve section. The first valve section 67 may include a flow path 68 and a second seal section 69.

The first shaft section 66 is inserted into the first communication path 57 and the second communication path 58. The first shaft section 66 is at least partially arranged in the pressure chamber 55. The first shaft section 66 is contactable with the first flexible section 63. The first shaft section 66 moves following the displacement of the first flexible section 63. The first shaft section 66 of the present embodiment is fixed to the first flexible section 63. The first shaft section 66 may be rod-shaped. The first shaft section 66 may be cylindrical-shaped. The diameter of the first shaft section 66 is smaller than the inner diameter of the first communication path 57. The diameter of the first shaft section 66 is smaller than the inner diameter of the second communication path 58.

The first valve section 67 is coupled to the first shaft section 66. The first valve section 67 is openable and closable with respect to the first communication path 57. The first valve section 67 can regulate the flow of the liquid from the supply chamber 54 toward the pressure chamber 55. The first shaft section 66 and the second seal section 69 are movable with respect to the inner periphery of the first communication path 57.

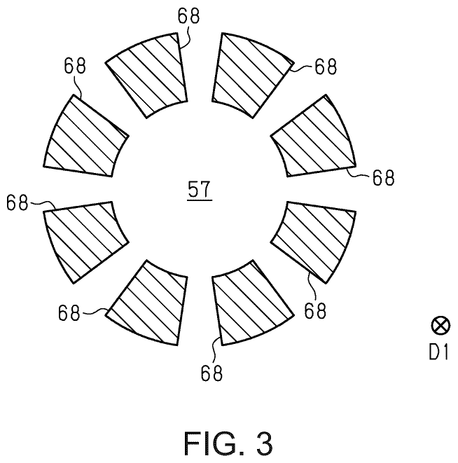

As shown in FIG. 3, the flow path 68 is provided at the inner periphery of the first communication path 57. The flow path 68 couples the first communication path 57 and the pressure chamber 55. The opening and closing section 59 may have a plurality of flow paths 68. The plurality of flow paths 68 may be radially formed from the first communication path 57.

As shown in FIG. 2, the first seal section 60 and the second seal section 69 move together with the first shaft section 66. The first shaft section 66, the first seal section 60, and the second seal section 69 are movable between a closed position indicated by the solid line in FIG. 2 and an open position indicated by the two-dot chain line in FIG. 2. When the second seal section 69 is in the closed position, the flow path 68 does not allow the supply chamber 54 and the pressure chamber 55 to communicate with each other. When the second seal section 69 is in the open position, the flow path 68 brings the supply chamber 54 and the pressure chamber 55 into communication.

The first seal section 60 is provided at the outer periphery of the first shaft section 66. The first seal section 60 forms a seal with the inner periphery of the second communication path 58. The first seal section 60 may be annular. The first seal section 60 has a first arm section 60a and a second arm section 60b. In the first arm section 60a and the second arm section 60b, the surfaces facing each other receive pressure from the liquid in the supply chamber 54, and the opposite surfaces receive pressure from the liquid in the pressure chamber 55.

The first arm section 60a is positioned inside the second arm section 60b. The first arm section 60a is closer to the outer periphery of the first shaft section 66 the further along the first arm section 60a in the first direction D1. The tip end of the first arm section 60a can be brought into intimate contact with the first shaft section 66.

The second arm section 60b is located outside the first arm section 60a. The second arm section 60b is closer to the inner periphery of the second communication path 58 the further along the second arm section 60b in the first direction D1. The tip end of the second arm section 60b can be brought into intimate contact with the inner surface of the second communication path 58.

The second seal section 69 is provided at the outer periphery of the first shaft section 66. The second seal section 69 forms a seal between the inner periphery of the first communication path 57 and the outer periphery of the first shaft section 66. The second seal section 69 may be annular. The second seal section 69 has a third arm section 69c and a fourth arm section 69d. In the third arm section 69c and the fourth arm section 69d, surfaces facing each other receive a pressure from the liquid in the supply chamber 54, and opposite surfaces receive a pressure from the liquid in the pressure chamber 55.

The third arm section 69c is positioned inside the fourth arm section 69d. The third arm section 69c is closer to the outer periphery of the first shaft section 66 the further along the third arm section 69c in a direction opposite to the first direction D1. The tip end of the third arm section 69c can be brought into intimate contact with the first shaft section 66.

The fourth arm section 69d is located outside the third arm section 69c. The fourth arm section 69d is closer to the inner periphery of the first communication path 57 the further along the fourth arm section 69d in the direction opposite to the first direction D1. The tip end of the fourth arm section 69d can be brought into intimate contact with the inner surface of the first communication path 57.

### Operation of Positive Pressure Adjustment Mechanism

The positive pressure adjustment mechanism 51 reduces the pressure of the liquid flowing into the supply chamber 54 and causes the liquid to flow out from the pressure chamber 55. The pressure of the liquid flowing into the supply chamber 54 and the pressure of the liquid flowing out from the pressure chamber 55 are both positive pressures.

The first shaft section 66 moves according to the variation of the pressure in the pressure chamber 55. When the pressure in the pressure chamber 55 decreases, the first shaft section 66 is pushed by the first flexible section 63 and moves to the open position. The second seal section 69 moves to the open position together with the first shaft section 66. Therefore, the supply chamber 54 and the pressure chamber 55 communicate with each other, and the liquid is supplied from the supply chamber 54 to the pressure chamber 55. The first seal section 60 closes the second communication path 58 both in the open position and in the closed position.

When the pressure in the pressure chamber 55 increases, the first flexible section 63 moves in a direction away from the second communication path 58. The first shaft section 66 moves to the closed position together with the first flexible section 63. Therefore, the supply of the liquid from the supply chamber 54 to the pressure chamber 55 is stopped.

The sealability of the first seal section 60 and the second seal section 69 changes by the pressure in the supply chamber 54. Specifically, in a case where the pressure in the supply chamber 54 increases, the liquid in the supply chamber 54 pushes the first seal section 60 and the second seal section 69 so as to be widened. More specifically, the first seal section 60 enhances the sealability between the first shaft section 66 and the second communication path 58 by receiving a force such that the tip end of the first arm section 60a and the tip end of the second arm section 60b are separated from each other. The second seal section 69 enhances the sealability between the first shaft section 66 and the first communication path 57 by receiving forces that separate the tip end of the third arm section 69c and the tip end of the fourth arm section 69d from each other. The first seal section 60 and the second seal section 69 may be provided same components in an inverted manner. The area where the first seal section 60 is in contact with the liquid in the supply chamber 54 may be substantially the same as the area where the second seal section 69 is in contact with the liquid in the supply chamber 54. In this case, even if the pressure in the supply chamber 54 increases, the first shaft section 66 does not move from the closed position.

### Negative Pressure Adjustment Mechanism

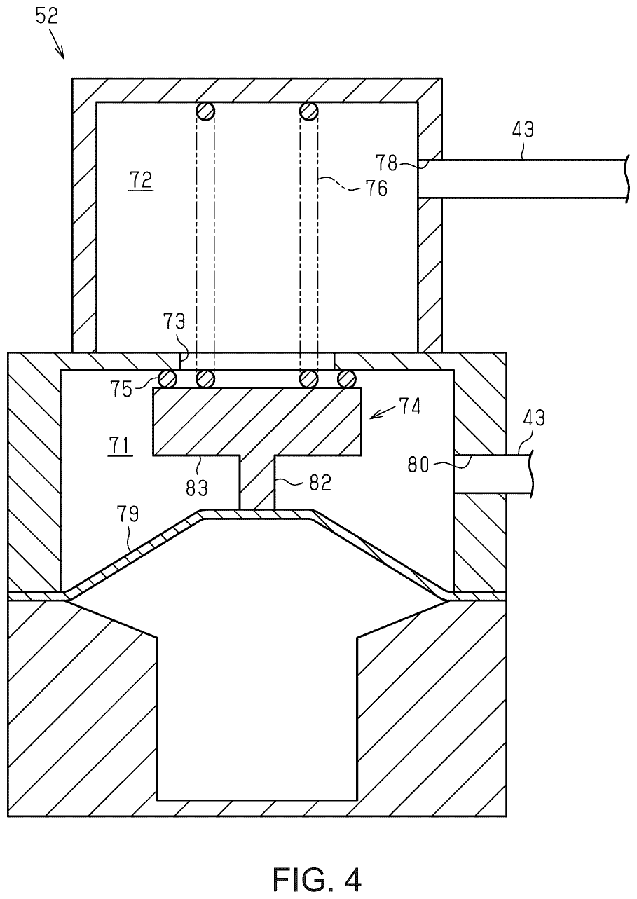

As shown in FIG. 4, the negative pressure adjustment mechanism 52 may include an upstream chamber 71, a downstream chamber 72, a third communication path 73, a restricting section 74, a third seal section 75, and a biasing member 76.

The downstream chamber 72 has a second outflow port 78 through which liquid flows out.

The upstream chamber 71 is provided upstream of the downstream chamber 72. The upstream chamber 71 has a second flexible section 79. The second flexible section 79 is formed of a flexible member having flexibility such as a diaphragm. The upstream chamber 71 has a second inflow port 80 into which the liquid flows.

The third communication path 73 brings the upstream chamber 71 and the downstream chamber 72 into communication.

The restricting section 74 is provided in the upstream chamber 71. The restricting section 74 can regulate the flow of the liquid from the upstream chamber 71 toward the downstream chamber 72. The restricting section 74 may have a second shaft section 82 and a second valve section 83. The second shaft section 82 and the second valve section 83 may be integrally formed.

The second shaft section 82 may be rod-shaped. The second shaft section 82 may be cylindrical-shaped. The tip end of the second shaft section 82 is contactable with the second flexible section 79. The restricting section 74 moves following the displacement of the second flexible section 79.

The second valve section 83 is coupled to the second shaft section 82. The second valve section 83 may be cylindrical-shaped. The second valve section 83 may be plate-shaped. The diameter of the second valve section 83 is larger than the diameter of the second shaft section 82 and the inner diameter of the third communication path 73.

The third seal section 75 may be provided in the upstream chamber 71. The third seal section 75 may be provided around the third communication path 73. The third seal section 75 seals between the restricting section 74 and the inner surface of the upstream chamber 71. The restricting section 74 closes the third communication path 73 by the intimate contact of the second valve section 83 with the third seal section 75.

The biasing member 76 is provided in the downstream chamber 72. A portion of the biasing member 76 is inserted into the third communication path 73. The biasing member 76 pushes the restricting section 74 in a direction away from the third communication path 73. The biasing member 76 is, for example, a spring.

### Operation of Negative Pressure Adjustment Mechanism

The pressure in the upstream chamber 71 and the downstream chamber 72 are both negative pressures. The negative pressure adjustment mechanism 52 makes the magnitude of the negative pressure in the upstream chamber 71 smaller than the magnitude of the negative pressure in the downstream chamber 72.

When the negative pressure in the upstream chamber 71 decreases, the force with which the liquid in the upstream chamber 71 pulls the second flexible section 79 decreases. When the force with which the liquid in the upstream chamber 71 pulls the second flexible section 79 becomes weaker than the force with which the biasing member 76 pushes the second flexible section 79 via the restricting section 74, the restricting section 74 opens the third communication path 73. Since the negative pressure of the upstream chamber 71 is smaller than the negative pressure of the downstream chamber 72, when the third communication path 73 is opened, the negative pressure of the upstream chamber 71 increases.

When the negative pressure in the upstream chamber 71 increases, the force of the liquid in the upstream chamber 71 pulling the second flexible section 79 increases. When the force with which the liquid in the upstream chamber 71 pulls the second flexible section 79 becomes stronger than the force with which the biasing member 76 pushes the second flexible section 79 via the restricting section 74, the restricting section 74 closes the third communication path 73.

### Operation of the Embodiment

The operation of the present embodiment will be described.

The pressure of the liquid supplied from the first tank 25 to the liquid ejection head 12 is adjusted by the positive pressure adjustment mechanism 51. Therefore, the liquid having a pressure smaller than the pressure in the pressurized first tank 25 is supplied to the liquid ejection head 12.

The pressure of the liquid collected from the liquid ejection head 12 is adjusted by the negative pressure adjustment mechanism 52. Therefore, the negative pressure applied to the liquid ejection head 12 is smaller than the negative pressure in the depressurized second tank 26.

### Effect of the Embodiment

The effect of the present embodiment will be described.

1-1: The first seal section 60 includes the first arm section 60a and the second arm section 60b. The first arm section 60a is closer to the outer periphery of the first shaft section 66 the further along the first arm section 60a in the first direction D1. The second arm section 60b is closer to the inner periphery of the second communication path 58 the further along the second arm section 60b in the first direction D1. When the pressure of the supply chamber 54 is high, the first seal section 60 receives a force such that the first arm section 60a and the second arm section 60b open, increasing the sealability. Therefore, even if the pressure in the supply chamber 54 increases, it is possible to reduce the leakage of liquid from the supply chamber 54 to the pressure chamber 55 via the second communication path 58. When the pressure of the supply chamber 54 decreases, the force that is applied to the first seal section 60 and that opens the first arm section 60a and the second arm section 60b, is reduced, thereby also reducing the frictional resistance. Therefore, the leakage of the liquid can be reduced while the frictional resistance is reduced.

1-2: The second seal section 69 seals between the first communication path 57 and the first shaft section 66. Since the first shaft section 66 and the second seal section 69 switch the communication state between the supply chamber 54 and the pressure chamber 55 by moving with respect to the inner periphery of the first communication path 57, it is possible to reduce leakage of liquid from the first communication path 57.

1-3: The positive pressure adjustment mechanism 51 is provided in the positive pressure path 42. Therefore, the pressure of the liquid supplied to the liquid ejection head 12 can be stabilized.

1-4: The coupling path 41 couples the second tank 26 coupled to the negative pressure path 43 and the first tank 25 coupled to the positive pressure path 42. Therefore, the liquid collected from the liquid ejection head 12 can be supplied to the liquid ejection head 12 again.

### MODIFIED EXAMPLE

The present embodiment can be implemented with the following modifications. The present embodiment and the following modified examples can be implemented in combination with each other within a technically compatible range. In the present embodiment and the following modified examples, the same components are denoted by the same reference numerals, and redundant description thereof will be omitted.

### FIRST MODIFIED EXAMPLE

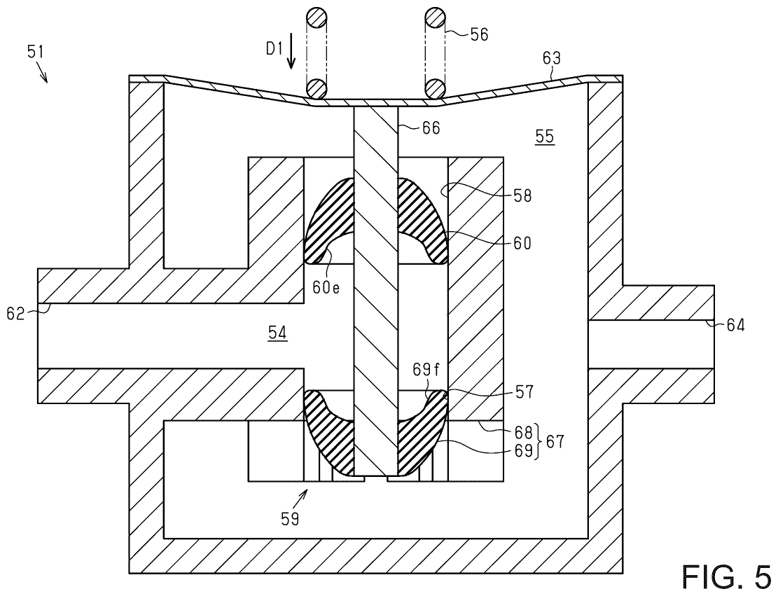

As shown in FIG. 5, the first seal section 60 may have a fifth arm section 60e that is an example of the arm section. The first seal section 60 is provided at the first shaft section 66 and moves together with the first shaft section 66. The fifth arm section 60e is provided at the outer periphery of the first shaft section 66. The fifth arm section 60e is closer to the inner periphery of the second communication path 58 the further along the fifth arm section 60e in the first direction D1.

The second seal section 69 may have a sixth arm section 69f that is an example of an arm section. The second seal section 69 is provided at the first shaft section 66. The second seal section 69 moves together with the first shaft section 66. The sixth arm section 69f is provided at the outer periphery of the first shaft section 66. The sixth arm section 69f is closer to the inner periphery of the first communication path 57 the further along the sixth arm section 69f in the direction opposite to the first direction D1.

The first seal section 60 and the second seal section 69 may be formed integrally with the first shaft section 66. For example, the first seal section 60, the second seal section 69, and the first shaft section 66 may be formed by a doublemolding.

The first seal section 60 and the second seal section 69 may be provided same components in an inverted manner. The area where the first seal section 60 is in contact with the liquid in the supply chamber 54 may be substantially the same as the area where the second seal section 69 is in contact with the liquid in the supply chamber 54.

### Operation of First Modified Example

When the pressure in the pressure chamber 55 decreases, the first shaft section 66 is pressed by the pressurizing section 56 and the first flexible section 63, and moves in the first direction D1. The second seal section 69 moves to the open position together with the first shaft section 66. Therefore, the supply chamber 54 and the pressure chamber 55 communicate with each other, and the liquid is supplied from the supply chamber 54 to the pressure chamber 55.

When the pressure in the pressure chamber 55 increases, the first flexible section 63 moves in a direction away from the second communication path 58. The first shaft section 66 moves in the direction opposite to the first direction D1 together with the first flexible section 63. The first valve section 67 moves to the closed position to close the first communication path 57. Therefore, the supply of the liquid from the supply chamber 54 to the pressure chamber 55 is stopped.

The sealability of the first seal section 60 and the second seal section 69 changes by the pressure in the supply chamber 54. Specifically, when the pressure in the supply chamber 54 increases, the liquid in the supply chamber 54 presses the fifth arm section 60e against the inner surface of the second communication path 58. Therefore, the first seal section 60 enhances the sealability between the first shaft section 66 and the second communication path 58. When the pressure in the supply chamber 54 increases, the liquid in the supply chamber 54 presses the sixth arm section 69f against the inner surface of the first communication path 57. Therefore, the second seal section 69 enhances the sealability between the first shaft section 66 and the first communication path 57. Even if the pressure in the supply chamber 54 increases, the first shaft section 66 does not move from the closed position.

### Effect of First Modified Example

The first seal section 60 has the fifth arm section 60e. The fifth arm section 60e is closer to the inner periphery of the second communication path 58 the further along the fifth arm section 60e in the first direction D1. When the pressure in the supply chamber 54 is high, the first seal section 60 receives a force such that the tip end of the fifth arm section 60e is pressed against the inner periphery of the second communication path 58, thereby increasing the sealability. Therefore, even if the pressure in the supply chamber 54 increases, it is possible to reduce the leakage of liquid from the supply chamber 54 to the pressure chamber 55 via the second communication path 58. When the pressure in the supply chamber 54 decreases, the force applied to press the fifth arm section 60e against the second communication path 58 decreases, so that the frictional resistance also decreases. Therefore, the leakage of the liquid can be reduced while the frictional resistance is reduced.

The second seal section 69 has the sixth arm section 69f. The sixth arm section 69f is closer to the inner periphery of the first communication path 57 the further along the sixth arm section 69f in the direction opposite to the first direction D1. Therefore, when the pressure in the supply chamber 54 is high, the sealability of the second seal section 69 increases, whereas when the pressure in the supply chamber 54 is low, the sealability of the second seal section 69 decreases. Therefore, the leakage of the liquid can be reduced while the frictional resistance is reduced.

### SECOND MODIFIED EXAMPLE

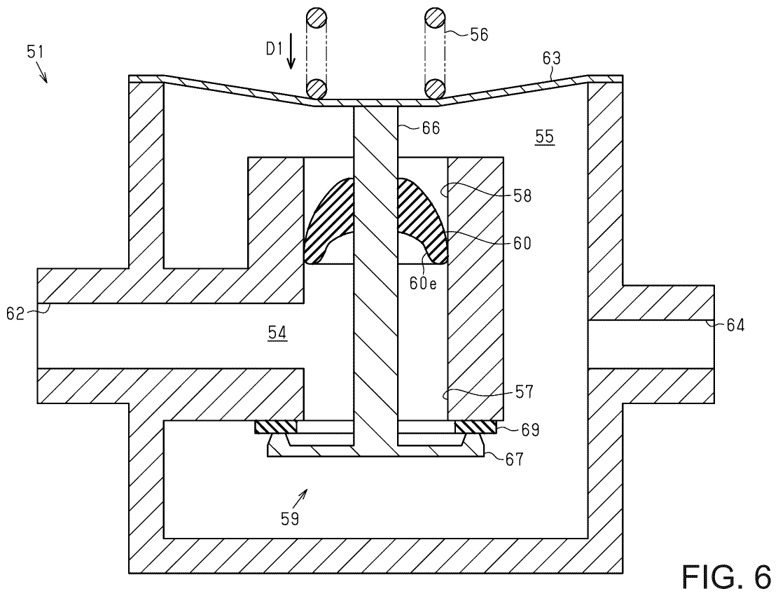

As shown in FIG. 6, the second seal section 69 may be provided outside the first communication path 57. The second seal section 69 and the first valve section 67 may be provided in the pressure chamber 55. The second seal section 69 may be provided around the opening on the pressure chamber 55 side of the first communication path 57. The first valve section 67 may be cylindrical shaped. The first valve section 67 may be plate-shaped. The diameter of the first valve section 67 is larger than the diameter of the first shaft section 66 and the inner diameter of the first communication path 57.

The area where the first valve section 67 is in contact with the liquid in the supply chamber 54 may be substantially the same as the area where the first seal section 60 is in contact with the liquid in the supply chamber 54. The first valve section 67 closes the first communication path 57 by the intimate contact with the second seal section 69. The first valve section 67 is configured to close the opening of the pressure chamber 55 side of the first communication path 57.

### Operation of Second Modified Example

When the pressure in the pressure chamber 55 decreases, the first shaft section 66 is pressed by the pressurizing section 56 and the first flexible section 63, and moves in the first direction D1. The first valve section 67 moving in the first direction D1 with the first shaft section 66 opens the first communication path 57 by being separated from the second seal section 69. By this, the liquid is supplied from the supply chamber 54 to the pressure chamber 55.

When the pressure in the pressure chamber 55 increases, the first flexible section 63 moves in a direction away from the second communication path 58. The first shaft section 66 moves in the direction opposite to the first direction D1 together with the first flexible section 63. The first valve section 67 that has moved to the closed position comes into intimate contact with the second seal section 69 to close the first communication path 57. Therefore, the supply of the liquid from the supply chamber 54 to the pressure chamber 55 is stopped. Even if the pressure in the supply chamber 54 increases, the first shaft section 66 does not move from the closed position.

### Effect of Second Modified Example

The first valve section 67 can close the first communication path 57 from the pressure chamber 55 side. Therefore, the opening and closing section 59 can be configured with a simple configuration.

### THIRD MODIFIED EXAMPLE

In the third modified example, the second seal section 69 may be provided at the first valve section 67. The second seal section 69 may be an O-ring with a circular cross-section.

### FOURTH MODIFIED EXAMPLE

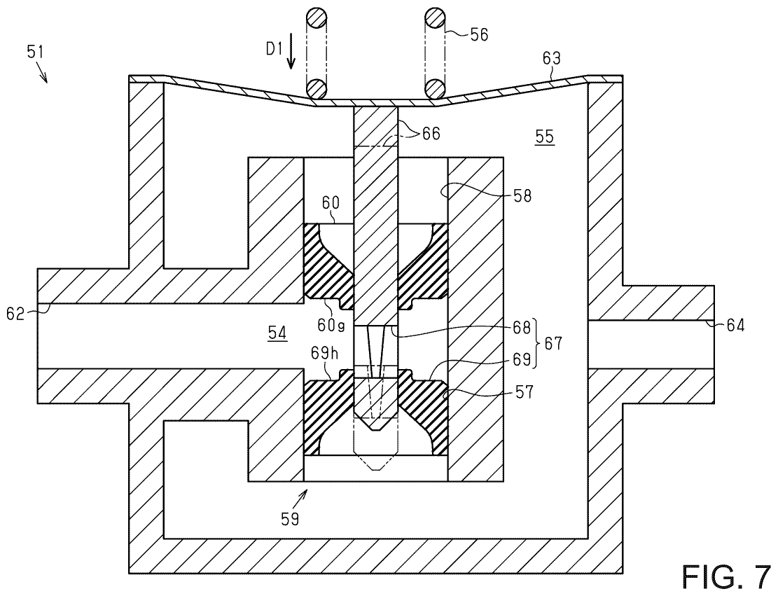

As shown in FIG. 7, the first seal section 60 may include a seventh arm section 60g that is an example of the arm section. The first seal section 60 is provided at the inner periphery of the second communication path 58. The first seal section 60 forms a seal with the outer periphery of the first shaft section 66. The first seal section 60 slides with respect to the moving first shaft section 66. The first shaft section 66 is movable with respect to the first seal section 60 and the second communication path 58. The seventh arm section 60g is closer to the outer periphery of the first shaft section 66 the further along the seventh arm section 60g in the first direction D1.

The second seal section 69 may have an eighth arm section 69h that is an example of an arm section. The second seal section 69 is provided at the inner periphery of the first communication path 57. The second seal section 69 forms a seal with the outer periphery of the first shaft section 66. The second seal section 69 slides with respect to the moving first shaft section 66. The first shaft section 66 is movable with respect to the second seal section 69 and the first communication path 57. The eighth arm section 69h is closer to the outer periphery of the first shaft section 66 the further along the eighth arm section 69h in the direction opposite to the first direction D1.

The first seal section 60 may be integrally formed with a member constituting the second communication path 58. The second seal section 69 may be integrally formed with a member constituting the first communication path 57. For example, the first seal section 60 and the second seal section 69 may be formed by the doublemolding at the inner surfaces of the first communication path 57 and the second communication path 58.

The flow path 68 is provided at the first shaft section 66. The first shaft section 66 is movable between a closed position indicated by the solid line in FIG. 7 and an open position indicated by the two-dot chain line in FIG. 7. When the second seal section 69 is in the closed position, the flow path 68 does not allow the supply chamber 54 and the pressure chamber 55 to communicate with each other. When the second seal section 69 is in the open position, the flow path 68 brings the supply chamber 54 and the pressure chamber 55 into communication.

### Operation of Fourth Modified Example

When the pressure in the pressure chamber 55 decreases, the first shaft section 66 is pressed by the pressurizing section 56 and the first flexible section 63, and moves in the first direction D1. When the first shaft section 66 is moved to the open position, the flow path 68 communicates the supply chamber 54 and the pressure chamber 55. The liquid is supplied from the supply chamber 54 to the pressure chamber 55.

When the pressure in the pressure chamber 55 increases, the first flexible section 63 moves in a direction away from the second communication path 58. When the first shaft section 66 is moved to the closed position, the supply of the liquid from the supply chamber 54 to the pressure chamber 55 is stopped.

When the pressure in the supply chamber 54 increases, the liquid in the supply chamber 54 presses the seventh arm section 60g against the outer periphery of the first shaft section 66. Therefore, the first seal section 60 enhances the sealability between the first shaft section 66 and the second communication path 58. When the pressure in the supply chamber 54 increases, the liquid in the supply chamber 54 presses the eighth arm section 69h against the outer surface of the first shaft section 66. Therefore, the second seal section 69 enhances the sealability between the first shaft section 66 and the first communication path 57. The first seal section 60 and the second seal section 69 may be provided same components in an inverted manner. The area where the first seal section 60 is in contact with the liquid in the supply chamber 54 may be substantially the same as the area where the second seal section 69 is in contact with the liquid in the supply chamber 54. In this case, even if the pressure in the supply chamber 54 increases, the first shaft section 66 does not move from the closed position.

### Effect of Fourth Modified Example

The first seal section 60 has the seventh arm section 60g. The seventh arm section 60g is closer to the outer periphery of the first shaft section 66 the further along the seventh arm section 60g in the first direction D1. When the pressure in the supply chamber 54 is high, the first seal section 60 receives a force such that the tip end of the seventh arm section 60g is pressed against the first shaft section 66, so that the sealability increases. Therefore, even if the pressure in the supply chamber 54 increases, it is possible to reduce the leakage of liquid from the supply chamber 54 to the pressure chamber 55 via the second communication path 58. When the pressure in the supply chamber 54 decreases, the force applied to press the seventh arm section 60g against the first shaft section 66 decreases, so that the frictional resistance also decreases. Therefore, the leakage of the liquid can be reduced while the frictional resistance is reduced.

The second seal section 69 seals between the first communication path 57 and the first shaft section 66. Since the first shaft section 66 switches the communication state between the supply chamber 54 and the pressure chamber 55 by moving with respect to the second seal section 69 and the inner periphery of the first communication path 57, it is possible to reduce leakage of liquid from the first communication path 57.

The second seal section 69 has the eighth arm section 69h. The eighth arm section 69h is closer to the outer periphery of the first shaft section 66 the further along the eighth arm section 69h in the direction opposite to the first direction D1. Therefore, when the pressure in the supply chamber 54 is high, the sealability of the second seal section 69 increases, whereas when the pressure in the supply chamber 54 is low, the sealability of the second seal section 69 decreases. Therefore, the leakage of the liquid can be reduced while the frictional resistance is reduced.

### FIFTH MODIFIED EXAMPLE

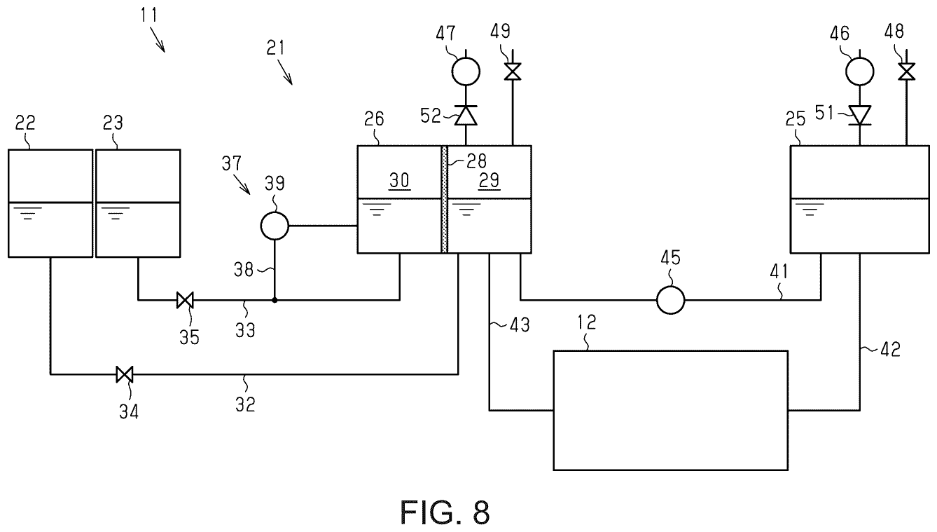

As shown in FIG. 8, at least either of the positive pressure adjustment mechanism 51 or the negative pressure adjustment mechanism 52 may be provided in the air flow path. The air flow path communicates with the liquid ejection head 12 via the flow path for supplying the liquid.

The positive pressure adjustment mechanism 51 may be provided in a flow path between the pressurizing pump 46 and the first tank 25. The flow path couples the pressurizing pump 46 and the supply chamber 54. The flow path couples the pressure chamber 55 and the first tank 25. The positive pressure adjustment mechanism 51 may adjust the pressurized air supplied by the pressurizing pump 46 and supply the air to the first tank 25.

The negative pressure adjustment mechanism 52 may be provided in a flow path between the vacuum pump 47 and the second tank 26. The flow path couples the second tank 26 and the upstream chamber 71. The flow path couples the downstream chamber 72 and the vacuum pump 47. The negative pressure adjustment mechanism 52 may adjust the negative pressure created by the vacuum pump 47 and act on the second tank 26.

### SIXTH MODIFIED EXAMPLE

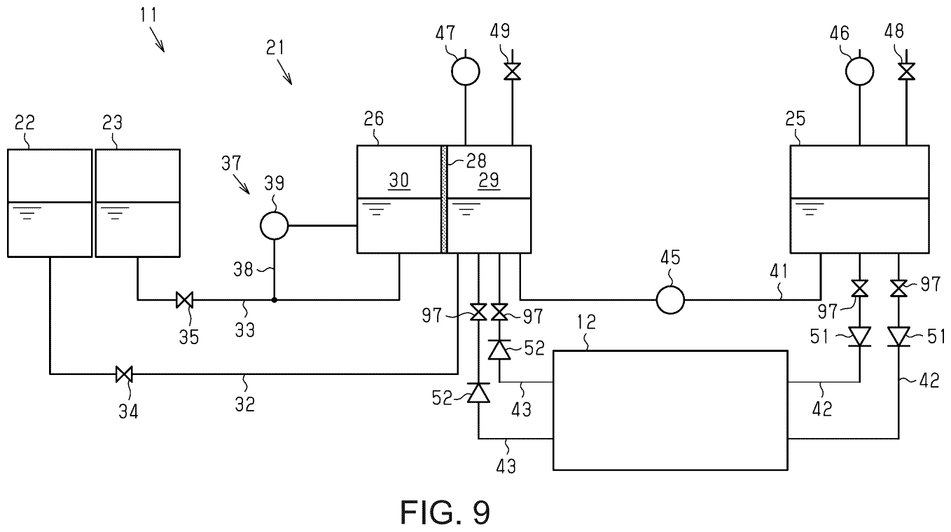

As shown in FIG. 9, the liquid ejection device 11 may include a plurality of positive pressure adjustment mechanism 51. The liquid ejection device 11 may include a plurality of negative pressure adjustment mechanisms 52. A plurality of positive pressure adjustment mechanisms 51 may have different pressures after adjustment. The plurality of negative pressure adjustment mechanisms 52 may have different pressures after adjustment.

The liquid ejection device 11 may include a plurality of positive pressure paths 42, a plurality of negative pressure paths 43, and a plurality of opening and closing valves 97. The opening and closing valve 97 and the positive pressure adjustment mechanism 51 may be provided in the positive pressure path 42. The negative pressure adjustment mechanism 52 and the opening and closing valve 97 may be provided in the negative pressure path 43. The plurality of positive pressure adjustment mechanisms 51 may be provided in parallel. The plurality of negative pressure adjustment mechanisms 52 may be provided in parallel. The liquid ejection device 11 may select the positive pressure adjustment mechanism 51 and the negative pressure adjustment mechanism 52 to be used by opening and closing the opening and closing valve 97.

For example, when the liquid is circulated, the liquid ejection device 11 may use the positive pressure adjustment mechanism 51 with a small pressure after adjustment and the negative pressure adjustment mechanism 52 with a small negative pressure after adjustment. When the liquid is circulated, a low pressure liquid may be supplied to the liquid ejection head 12 and a small negative pressure may be applied to the liquid ejection head 12.

For example, when filling the liquid ejection head 12 with liquid, the liquid ejection device 11 may use the positive pressure adjustment mechanism 51 with a large pressure after adjustment and the negative pressure adjustment mechanism 52 with a large negative pressure after adjustment. That is, at the time of filling, a liquid having a large pressure may be supplied to the liquid ejection head 12 and a large negative pressure may be applied to the liquid ejection head 12.

### SEVENTH MODIFIED EXAMPLE

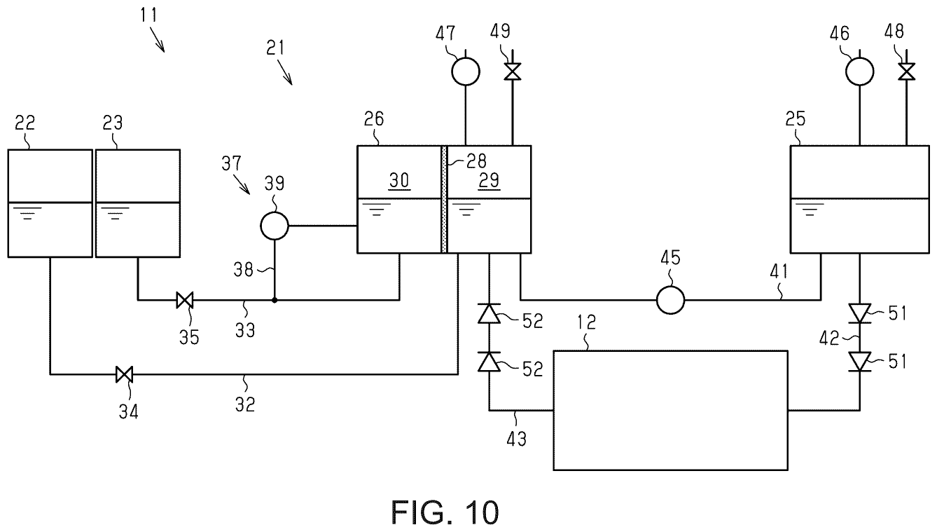

As shown in FIG. 10, the plurality of positive pressure adjustment mechanisms 51 may be provided in a single positive pressure path 42. The plurality of positive pressure adjustment mechanisms 51 may be provided in series. The positive pressure adjustment mechanism 51 having a large pressure after adjustment may be provided at a position closer to the first tank 25 than the positive pressure adjustment mechanism 51 having a small pressure after adjustment. The plurality of positive pressure adjustment mechanisms 51 may gradually decrease the pressure of the liquid flowing from the first tank 25 to the liquid ejection head 12. By this, it is possible to accurately adjust the pressure of the liquid supplied to the liquid ejection head 12.

The plurality of negative pressure adjustment mechanisms 52 may be provided in a single negative pressure path 43. The plurality of negative pressure adjustment mechanisms 52 may be provided in series. The negative pressure adjustment mechanism 52 having a small negative pressure after adjustment may be provided at a position closer to the liquid ejection head 12 than the negative pressure adjustment mechanism 52 having a large negative pressure after adjustment. Each of the plurality of negative pressure adjustment mechanisms 52 may sequentially reduce the negative pressure from the second tank 26 to the liquid ejection head 12. By this, this makes it possible to accurately adjust the negative pressure applied to the liquid ejection head 12.

### EIGHTH MODIFIED EXAMPLE

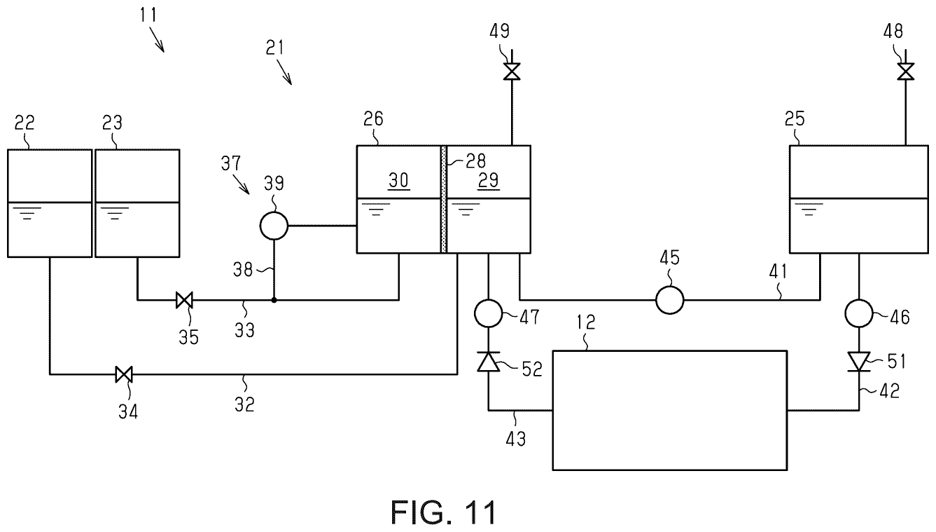

As shown in FIG. 11, the pressurizing pump 46 may be provided in the positive pressure path 42. The pressurizing pump 46 may be provided between the first tank 25 and the positive pressure adjustment mechanism 51. The pressurizing pump 46 sends the liquid in the first tank 25 toward the liquid ejection head 12.

The vacuum pump 47 may be provided in the negative pressure path 43. The vacuum pump 47 may be provided between the negative pressure adjustment mechanism 52 and the second tank 26. The vacuum pump 47 sends the liquid from the liquid ejection head 12 toward the second tank 26.

### NINTH MODIFIED EXAMPLE

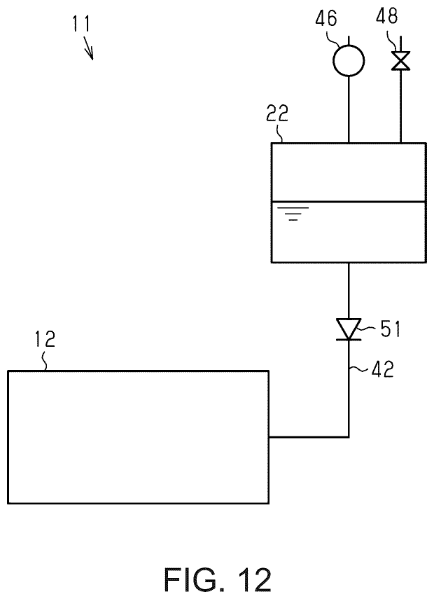

As shown in FIG. 12, the liquid ejection device 11 includes the liquid ejection head 12, the positive pressure path 42, and the positive pressure adjustment mechanism 51. The positive pressure path 42 may be coupled to the liquid source 22. The pressurizing pump 46 may pressurize the liquid contained in the liquid source 22. The first atmosphere air open valve 48 can set the pressure applied to the liquid in the liquid source 22 to atmospheric pressure.

### TENTH MODIFIED EXAMPLE

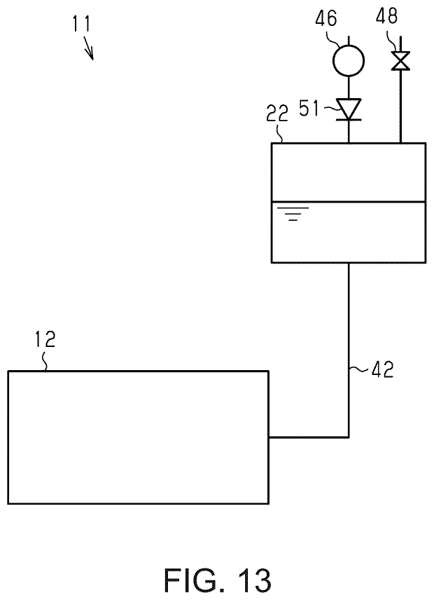

As shown in FIG. 13, the positive pressure adjustment mechanism 51 may be provided in a flow path between the pressurizing pump 46 and the liquid source 22.

### ELEVENTH MODIFIED EXAMPLE

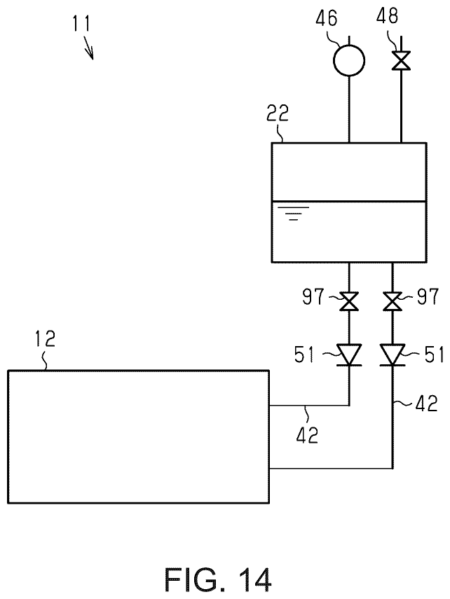

As shown in FIG. 14, the liquid ejection device 11 may include the plurality of positive pressure paths 42, the plurality of positive pressure adjustment mechanisms 51, and a plurality of opening and closing valves 97. The plurality of positive pressure adjustment mechanisms 51 may be provided in parallel to the plurality of positive pressure paths 42.

### TWELFTH MODIFIED EXAMPLE

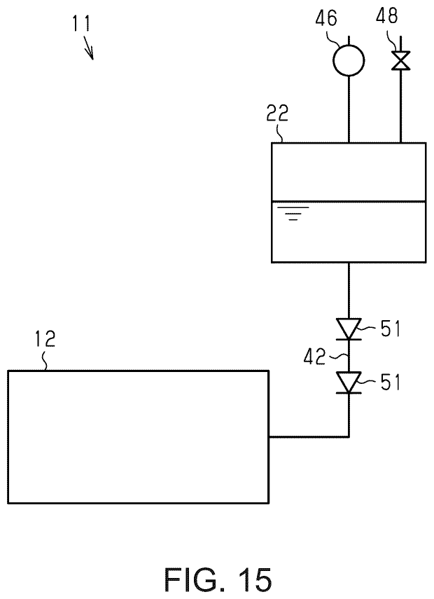

As shown in FIG. 15, the liquid ejection device 11 may includes the plurality of positive pressure adjustment mechanisms 51. The plurality of positive pressure adjustment mechanisms 51 may be provided in series in the positive pressure path 42.

### THIRTEENTH MODIFIED EXAMPLE

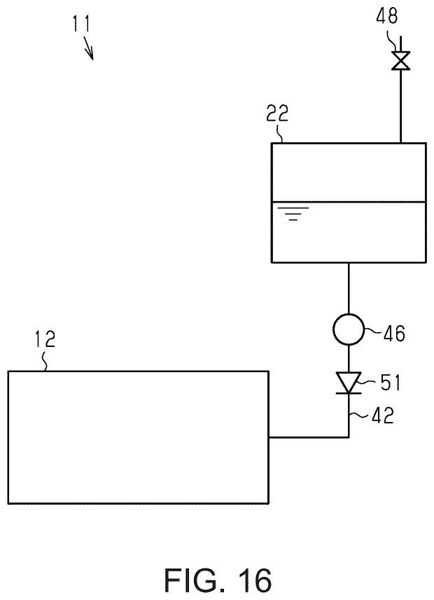

As shown in FIG. 16, the pressurizing pump 46 may be provided in the positive pressure path 42. The pressurizing pump 46 may be provided between the liquid source 22 and the positive pressure adjustment mechanism 51.

### Other Modified Example

The liquid ejection device 11 may include one positive pressure adjustment mechanism 51 and the plurality of negative pressure adjustment mechanisms 52. The liquid ejection device 11 may include the plurality of positive pressure adjustment mechanisms 51 and one negative pressure adjustment mechanism 52.
The plurality of positive pressure adjustment mechanisms 51 may be provided in parallel, and the plurality of negative pressure adjustment mechanisms 52 may be provided in series.
The plurality of positive pressure adjustment mechanisms 51 may be provided in series, and the plurality of negative pressure adjustment mechanisms 52 may be provided in parallel.
The liquid ejection device 11 may include three or more positive pressure adjustment mechanisms 51. Three or more positive pressure adjustment mechanisms 51 may be provided in series. In the three or more positive pressure adjustment mechanisms 51, at least two of the positive pressure adjustment mechanisms 51 may be provided in series, while the other positive pressure adjustment mechanisms 51 may be provided in parallel to the positive pressure adjustment mechanisms 51 provided in series.
The liquid ejection device 11 may include three or more negative pressure adjustment mechanisms 52. Three or more negative pressure adjustment mechanisms 52 may be provided in series. In three or more negative pressure adjustment mechanisms 52, together with at least two of the negative pressure adjustment mechanisms 52 provided in series, another negative pressure adjustment mechanism 52 may be provided in parallel to the negative pressure adjustment mechanism 52 provided in series.
The negative pressure path 43 may couple the liquid ejection head 12 and the first tank 25.
The second seal section 69 for sealing between the outer periphery of the first shaft section 66 and the inner periphery of the first communication path 57 may be the O-ring. For example, in the case where the first shaft section 66 is thin, the frictional resistance between the first communication path 57 and the second seal section 69 can be reduced even by using the O-ring for the second seal section 69.
The positive pressure adjustment mechanism 51 may arbitrarily combine the first seal section 60 and the opening and closing section 59 in the embodiment and the modified examples.
The liquid ejection device 11 may be a liquid ejection device that ejects or discharges liquid other than ink. The state of the liquid which is ejected from the liquid ejection device in the form of a minute amount of liquid droplets includes a granular shape, a tear shape, and a shape with a thread-like tail. Here, the liquid may be a material which can be ejected from the liquid ejection device. For example, the liquid may be in a state where a substance is in a liquid phase, and includes a fluid body such as a liquid body having high or low viscosity, a sol, gel water, other inorganic solvents, an organic solvent, a solution, a liquid resin, a liquid metal, and a metal melt. The liquid includes not only a liquid as one state of a substance but also a liquid in which particles of a functional material made of a solid material such as a pigment or metal particles are dissolved, dispersed, or mixed in a solvent. Typical examples of the liquid include ink and liquid crystal as described in the above embodiment. Here, the ink includes various liquid compositions such as general water-based ink, oil-based ink, gel ink, and hot-melt ink. As a specific example of the liquid ejection device, there is an apparatus that ejects a liquid containing a material such as an electrode material or a color material used for manufacturing a liquid crystal display, an electroluminescence display, a surface emitting display, a color filter, or the like in a dispersed or dissolved form. The liquid ejection device may be a device for ejecting a bioorganic substance used for manufacturing a biochip, a device for ejecting a liquid to be a sample used as a precision pipette, a textile printing device, a microdispenser, or the like. The liquid ejection device may be a device that dispenses lubricating oil in a pinpoint manner to precision machinery such as watches or cameras, or a device that dispenses a transparent resin liquid such as an ultraviolet curable resin onto a substrate to form micro hemispherical lenses, optical lenses, or the like used in optical communication elements or similar applications. The liquid ejection device may be a device for dispensing an etching solution such as an acid or an alkali for etching a substrate or the like.

Hereinafter, technical ideas grasped from the above-described embodiment and modified example, and operational effects thereof will be described.

(A) A positive pressure adjustment mechanism includes a supply chamber with an inflow port into which liquid flows; a pressure chamber that has a flexible section formed of a flexible member and that has an outflow port arranged downstream of the supply chamber and from which the liquid flows out; a first communication path that brings the supply chamber and the pressure chamber into communication; a second communication path that is arranged coaxially with the first communication path and that brings the supply chamber and the pressure chamber into communication; an opening and closing section including a shaft section that is inserted into the first communication path and the second communication path and that moves following the displacement of the flexible section, and a valve section that is coupled to the shaft section and that is configured to open and close the first communication path; a first seal section that forms a seal between an outer periphery of the shaft section and an inner periphery of the second communication path; and a pressurizing section configured to pressurize the flexible section in a first direction which decreases volume of the pressure chamber, wherein the first seal section includes a first arm section and a second arm section, the first arm section being closer to an outer periphery of the shaft section the further the first arm section is in first direction and the second arm section being closer to an inner periphery of the second communication path the further along the second arm section in the first direction.

According to this configuration, the first seal section includes a first arm section and a second arm section. The first arm section is closer to the outer periphery of the shaft section the further along the first arm section in the first direction. The second arm section is closer to the inner periphery of the second communication path the further along the second arm section in the first direction. When the pressure in the supply chamber is high, the first seal section receives a force such that the first arm section and the second arm section open, and thus the sealability of the first seal section increases. Therefore, even if the pressure in the supply chamber increases, it is possible to reduce the leakage of liquid from the supply chamber to the pressure chamber via the second communication path. When the pressure of the supply chamber decreases, the force that is applied to the first seal section and that opens the first arm section and the second arm section, is reduced, thereby also reducing the frictional resistance. Therefore, the leakage of the liquid can be reduced while the frictional resistance is reduced.

(B) A positive pressure adjustment mechanism includes a supply chamber with an inflow port into which liquid flows; a pressure chamber that has a flexible section formed of a flexible member and that has an outflow port arranged downstream of the supply chamber and from which the liquid flows out; a first communication path that brings the supply chamber and the pressure chamber into communication; a second communication path that s arranged coaxially with the first communication path and that brings the supply chamber and the pressure chamber into communication; an opening and closing section including a shaft section that is inserted into the first communication path and the second communication path and that moves following the displacement of the flexible section, and a valve section that is coupled to the shaft section and that is configured to open and close the first communication path; a first seal section provided at an outer periphery of the shaft section and configured to form a seal with an inner periphery of the second communication path, and a pressurizing section configured to pressurize the flexible section in a first direction which decreases volume of the pressure chamber, wherein the first seal section includes an arm section that is closer to an inner periphery of the second communication path the further along the arm section in the first direction.

According to this configuration, the first seal section has the arm section. The arm section is closer to the inner periphery of the second communication path the further along the arm section in the first direction. When the pressure in the supply chamber is high, the first seal section receives a force such that the tip end of the arm section is pressed against the inner periphery of the second communication path, and thus the sealability is increased. Therefore, even if the pressure in the supply chamber increases, it is possible to reduce the leakage of liquid from the supply chamber to the pressure chamber via the second communication path. When the pressure in the supply chamber decreases, the force applied to press the arm section against the second communication path decreases, so that the frictional resistance also decreases. Therefore, the leakage of the liquid can be reduced while the frictional resistance is reduced.

(C) A positive pressure adjustment mechanism includes a supply chamber with an inflow port into which liquid flows; a pressure chamber that has a flexible section formed of a flexible member and that has an outflow port arranged downstream of the supply chamber and from which the liquid flows out; a first communication path that brings the supply chamber and the pressure chamber into communication; a second communication path that is arranged coaxially with the first communication path and that brings the supply chamber and the pressure chamber into communication; an opening and closing section including a shaft section that is inserted into the first communication path and the second communication path and that moves following the displacement of the flexible section, and a valve section that is coupled to the shaft section and that is configured to open and close the first communication path; a first seal section arranged at an inner periphery of the second communication path and configured to form a seal with an outer periphery of the shaft section; and a pressurizing section configured to pressurize the flexible section in a first direction which decreases volume of the pressure chamber, wherein the first seal section includes an arm section that is closer to an outer periphery of the shaft section the further along the arm section in the first direction.

According to this configuration, the first seal section has the arm section. The arm section is closer to the outer periphery of the shaft section the further along the arm section in the first direction. When the pressure in the supply chamber is high, the first seal section receives a force such that the tip end of the arm section is pressed against the shaft section, so that the sealability increases. Therefore, even if the pressure in the supply chamber increases, it is possible to reduce the leakage of liquid from the supply chamber to the pressure chamber via the second communication path. When the pressure in the supply chamber decreases, the force applied to press the arm section against the shaft section decreases, so that the frictional resistance also decreases. Therefore, the leakage of the liquid can be reduced while the frictional resistance is reduced.

(D) In the positive pressure adjustment mechanism described in any one of (A) to (C), the valve section may be configured to close the pressure chamber side opening of the first communication path.

According to this configuration, the valve section can close the first communication path from the pressure chamber side. Therefore, the opening and closing section can be configured with a simple configuration.

(E) In the positive pressure adjustment mechanism described in any one of (A) to (C), the valve section may include a second seal section that forms a seal between an inner periphery of the first communication path and an outer periphery of the shaft section and a flow path provided at an inner periphery of the first communication path, wherein the shaft section and the second seal section are movable with respect to the inner periphery of the first communication path, and the flow path may be, when the second seal section is in the closed position, not in communication with the supply chamber or the pressure chamber, and when the second seal section is in the open position, in communication between the supply chamber and the pressure chamber.

According to this configuration, the second seal section seals between the first communication path and the shaft section. Since the shaft section and the second seal section switch the communication state between the supply chamber and the pressure chamber by moving with respect to the inner periphery of the first communication path, it is possible to reduce leakage of liquid from the first communication path.

(F) In the positive pressure adjustment mechanism described in (E), the second seal section may include an arm section that is arranged at an outer periphery of the shaft section, and that is closer to an inner periphery of the first communication path the further along the second seal section in a direction opposite to the first direction.

According to this configuration, the second seal section has the arm section. The arm section is closer to the inner periphery of the first communication path the further along the arm section in the direction opposite to the first direction. Therefore, when the pressure in the supply chamber is high, the sealability of the second seal section increases, whereas when the pressure in the supply chamber is low, the sealability of the second seal section decreases. Therefore, the leakage of the liquid can be reduced while the frictional resistance is reduced.

(G) In the positive pressure adjustment mechanism described in any one of (A) to (C), the valve section may include a second seal section that forms a seal between an inner periphery of the first communication path and an outer periphery of the shaft section and a flow path provided on a shaft section, wherein the shaft section is movable with respect to the second seal section and the first communication path, when the shaft section is in the closed position, the flow path is not in communication between the supply chamber or the pressure chamber, and when the shaft section is in the open position, the flow path may bring the supply chamber and the pressure chamber into communication.

According to this configuration, the second seal section seals between the first communication path and the shaft section. Since the shaft section switches the communication state between the supply chamber and the pressure chamber by moving with respect to the inner periphery of the second seal section and the first communication path, it is possible to reduce leakage of liquid from the first communication path.

(H) In the pressure adjustment mechanism described in (G), the second seal section is arranged at an inner periphery of the first communication path and may include an arm section that is closer to an outer periphery of the shaft section the further along the arm section in a direction opposite to the first direction.

According to this configuration, the second seal section has the arm section. The arm section is closer to the outer periphery of the shaft section the further along the arm section in the direction opposite to the first direction. Therefore, when the pressure in the supply chamber is high, the sealability of the second seal section increases, whereas when the pressure in the supply chamber is low, the sealability of the second seal section decreases. Therefore, the leakage of the liquid can be reduced while the frictional resistance is reduced.

(I) The liquid ejection device includes a liquid ejection head configured to eject liquid; a positive pressure path configured to supply the liquid to the liquid ejection head; and the positive pressure adjustment mechanism, according to any one of (A) to (H), arranged at the positive pressure path.

According to this configuration, the positive pressure adjustment mechanism is provided in the positive pressure path. Therefore, the pressure of the liquid supplied to the liquid ejection head can be stabilized.

(J) A liquid ejection device includes a liquid ejection head configured to eject liquid; a positive pressure path configured to supply the liquid to the liquid ejection head; a negative pressure path configured to collect the liquid from the liquid ejection head; an positive pressure adjustment mechanism having the above configuration provided at the positive pressure path; and a negative pressure adjustment mechanism arranged at the negative pressure path configured to adjust the negative pressure on the liquid ejection head side.

According to this configuration, it is possible to achieve the same effects as those of the liquid ejection device.

(K) The liquid ejection device may further include a first tank coupled to the positive pressure path and configured to contain the liquid to be supplied to the liquid ejection head; a second tank coupled to the negative pressure path and configured to contain the liquid collected from the liquid ejection head; a coupling path coupling the second tank and the first tank; a liquid delivery section that sends the liquid from the second tank to the first tank through the communication path; a pressurizing pump configured to pressurize the inside of the first tank; and a vacuum pump configured to reduce the pressure in the second tank.

According to this configuration, the connection flow path couples the second tank that is coupled to the negative pressure path, and the first tank that is coupled to the positive pressure path. Therefore, the liquid collected from the liquid ejection head can be supplied to the liquid ejection head again.

What is claimed is:

1. A positive pressure adjustment mechanism comprising:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section that forms a seal between an outer periphery of the shaft section and an inner periphery of the second communication path; and
a pressurizing section configured to pressurize the flexible section in a first direction which decreases volume of the pressure chamber, wherein
the first seal section includes a first arm section and a second arm section, the first arm section being closer to an outer periphery of the shaft section the further the first arm section is in first direction and the second arm section being closer to an inner periphery of the second communication path the further along the second arm section in the first direction.

2. A positive pressure adjustment mechanism comprising:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section arranged at an outer periphery of the shaft section and configured to form a seal with an inner periphery of the second communication path; and
a pressurizing section configured to pressurize the flexible section in a first direction which decreases volume of the pressure chamber, wherein
the first seal section includes an arm section that is closer to an inner periphery of the second communication path the further along the arm section in the first direction.

3. A positive pressure adjustment mechanism comprising:
a supply chamber with an inflow port into which liquid flows;
a pressure chamber that has a flexible section formed of a flexible member and that has an outflow port arranged downstream of the supply chamber and from which the liquid flows out;
a first communication path that brings the supply chamber and the pressure chamber into communication;
a second communication path that is arranged coaxially with the first communication path and that brings the supply chamber and the pressure chamber into communication;
an opening and closing section including a shaft section that is inserted into the first communication path and the second communication path and that moves following the displacement of the flexible section, and a valve section that is coupled to the shaft section and that is configured to open and close the first communication path;
a first seal section arranged at an inner periphery of the second communication path and configured to form a seal with an outer periphery of the shaft section; and
a pressurizing section configured to pressurize the flexible section in a first direction which decreases volume of the pressure chamber, wherein
the first seal section includes an arm section that is closer to an outer periphery of the shaft section the further along the arm section in the first direction.

4. The positive pressure adjustment mechanism according to claim 1, wherein
the valve section is configured to close the pressure chamber side opening of the first communication path.

5. The positive pressure adjustment mechanism according to claim 1, wherein
the valve section includes
a second seal section that forms a seal between an inner periphery of the first communication path and an outer periphery of the shaft section and
a flow path provided at the inner periphery of the first communication path,
the shaft section and the second seal section are movable with respect to the inner periphery of the first communication path, and
the flow path is,
when the second seal section is in the closed position, not in communication with the supply chamber or the pressure chamber, and
when the second seal section is in the open position, it brings the supply chamber and the pressure chamber into communication.

6. The positive pressure adjustment mechanism according to claim 5, wherein
the second seal section includes an arm section that is arranged at an outer periphery of the shaft section and that is closer to an inner periphery of the first communication path the further along the arm section in a direction opposite to the first direction.

7. The positive pressure adjustment mechanism according to claim 1, wherein
the valve section includes
a second seal section that forms a seal between an inner periphery of the first communication path and an outer periphery of the shaft section and
a flow path provided on a shaft section,
the shaft section is movable with respect to the second seal section and the first communication path,
when the shaft section is in the closed position, the flow path is not in communication between the supply chamber or the pressure chamber, and
when the shaft section is in the open position, the flow path brings the supply chamber and the pressure chamber into communication.

8. The positive pressure adjustment mechanism according to claim 7, wherein
the second seal section is arranged at an inner periphery of the first communication path and includes an arm section that is closer to an outer periphery of the shaft section the further along the arm section in a direction opposite to the first direction.

9. A liquid ejection device comprising:
a liquid ejection head configured to eject liquid;
a positive pressure path configured to supply the liquid to the liquid ejection head; and
the positive pressure adjustment mechanism, according to claim 1, arranged in the positive pressure path.

10. A liquid ejection device comprising:
a liquid ejection head configured to eject liquid;
a positive pressure path configured to supply the liquid to the liquid ejection head;
a negative pressure path configured to collect the liquid from the liquid ejection head;
the positive pressure adjustment mechanism according to claim 1, which is arranged in the positive pressure path; and
a negative pressure adjustment mechanism arranged in the negative pressure path configured to adjust the negative pressure on the liquid ejection head side.

11. The liquid ejection device according to claim 10, further comprising:
a first tank coupled to the positive pressure path and configured to contain the liquid to be supplied to the liquid ejection head;
a second tank coupled to the negative pressure path and configured to contain the liquid collected from the liquid ejection head;
a coupling path coupling the second tank and the first tank;
a liquid delivery section that sends the liquid from the second tank to the first tank through the coupling path;
a pressurizing pump configured to pressurize the inside of the first tank; and
a vacuum pump configured to reduce the pressure in the second tank.
